(19) United States
(12) Patent Application Publication
(10) Pub. No.: US 2026/0247036 A1
(43) Pub. Date: Aug. 20, 2026

(54) AUTOMATIC FOCUSING METHOD, LENS MODULE AND IMAGING DEVICE

(71) Applicant: GLENFLY TECH CO., LTD., Shanghai (CN)

(72) Inventor: Dantong LI, Shanghai (CN)

(21) Appl. No.: 19/193,907

(22) Filed: Apr. 29, 2025

(30) Foreign Application Priority Data
Feb. 14, 2025 (CN) 202510169626.3

(51) Int. Cl. H04N 23/67

(52) U.S. Cl. CPC H04N 23/673; H04N 23/675

(57) ABSTRACT

Automatic focusing method comprises: controlling lens to move stepwise along preset direction from initial scanning position with first step size, calculating first contrast; determining whether meeting first preset condition; arranging fine-scan position according to determination result; controlling lens to move stepwise along reverse direction of preset direction from fine-scan position with second step size, calculating second contrast of imaging region corresponding to each lens position; determining whether meeting second preset condition; if so, designating lens position corresponding to second contrast as target imaging position. By calculating first contrast and determining, it can determine quickly range of imaging focal length, by calculating second contrast and determining, it can determine target imaging position quickly. Since not all lens positions have to be traversed, and step size is adjustable, not only reduce focusing time consumption effectively, but adapt to all kinds of scenes, problem of how to achieve high-efficient automatic focusing is solved

### CROSS-REFERENCES TO RELATED APPLICATION

The present invention claims the priority of Chinese Patent Application No. 202510169626.3, filed on 14 Feb. 2025. The contents of the above application are incorporated herein by reference.

### TECHNICAL FIELD

The present application relates to the technical field of lens imaging, and more specifically, to an automatic focusing method, a lens module and an imaging device.

### BACKGROUND

With the development of an imaging technology, a lens module in an existing imaging device (such as a camera) usually has a function of autofocus (AF), thus when a shooting button is pressed down, the lens module will automatically adjust a position of each lens according to a distance of a target to be shot, so as to get a sharp image the target.

Currently, two most commonly used methods to achieve the autofocus are a PDAF (Phase Detection Auto Focus) and a CDAF (Contrast Detection Auto Focus). A focusing principle of the PDAF is that, reserving a plurality of pixel pairs of both left and right regularly at a plurality of different regions in a photosensitive element (such as an image sensor), applied to detecting a plurality of phases, wherein a phase difference between a left pixel and a right pixel is able to be applied to measuring an imaging definition of a corresponding region, that is, if a phase difference between two pixels of a same pixel pair is 0, it indicates that the region has a good image definition, otherwise if the phase difference is not 0, it indicates that the image is blurring. A focusing principle of the CDAF is that, measuring the image definition by calculating a difference or a contrast in a focus point region in the image, while a larger difference indicates a clearer image.

In an actual application process, when adopting the method of PDAF, it requires to read information of both left pixel and right pixel of a pixel pair in a focusing region before calculating a phase difference, followed by obtaining a motor control value required to make a current phase difference be zero according to a preset calibration information, and finally controlling a motor to move and drive the lens to a specific position before achieving a clear image. When adopting the method of CDAF, first controlling a motor to drive the lens to move along one direction, and calculating out a corresponding image contrast according to an algorithm, the image contrast in such a process will experience a process from small to large then to small again, then using an algorithm to control the motor to drive the lens to move to a lens location generating a relatively large image contrast, followed by moving the lens back and calculating again the image contrast finely, so as to find a lens location when a maximum image contrast occurs in a lens motion range, before achieving a clear image.

Although the method of PDAF has an advantage of both a high focusing precision and a high speed, it requires relatively more hardware recourses to be consumed due to a calculation amount is relatively large, and pre-storing the preset calibration information of the motor; further, the method of PDAF has a strict requirement on an illumination condition, either an illumination relatively weak or relatively strong will affect the imaging definition, making an application scene thereof limited. While the method of CDAF requires to traverse all the lens locations, before calculating out a point having a most definite contrast for each lens location, and experiences two stages of both coarse scanning and fine scanning, having a focusing process relatively long.

### SUMMARY

The technical purpose of the present application is to provide an automatic focusing method, a lens module and an imaging device, so as to solve the problem of achieving an autofocus with a high efficiency.

To solve the technical problem stated above, in an embodiment, an automatic focusing method is provided in a first aspect of the present application, comprising:
controlling a lens to move stepwise along a preset direction from an initial scanning position with a first step size, and calculating a first contrast of an imaging region corresponding to each lens position;
determining whether each of the first contrasts obtained by the calculation meets a first preset condition;
arranging a fine-scan position according to a determination result;
controlling the lens to move stepwise along a reverse direction of the preset direction from the fine-scan position with a second step size, and calculating a second contrast of the imaging region corresponding to each lens position;
determining whether each of the second contrasts obtained by calculation meets a second preset condition;
if a second contrast obtained by calculation meets the second preset condition, designating a lens position corresponding to the second contrast as a target imaging position.

Preferably, a method of the controlling a lens to move stepwise along a preset direction from an initial scanning position with a first step size, and calculating a first contrast of an imaging region corresponding to each lens position, comprising:
arranging the initial scanning position;
dividing the imaging region into a plurality of sub-regions;
controlling the lens to move stepwise along the preset direction from the initial scanning position with the first step size, and obtaining an imaging contrast of each sub-region corresponding to a current lens position;
calculating the first contrast corresponding to the current lens position according to the plurality of imaging contrasts of all the sub-regions corresponding to the current lens position.

Preferably, a method of the calculating the first contrast corresponding to the current lens position according to the plurality of imaging contrasts of all the sub-regions corresponding to the current lens position comprising:
arranging a weight of contrast for each sub-region, wherein a weight of contrast for a sub-region locating at a center of the imaging region is higher than a weight of contrast for a sub-region locating on a periphery of the imaging region;
performing a weighted calculation on the plurality of imaging contrasts of all the sub-regions corresponding to the current lens position according to the plurality of weights of contrast, so as to obtain the first contrast corresponding to the current lens position.

Preferably, a method of the determining whether each of the first contrasts obtained by the calculation meets the first preset condition, comprising:

if a first preset multiplication of the first contrast corresponding to the current lens position is greater than a first contrast corresponding to a previous lens position and greater than a first contrast corresponding to a next lens position, it is determined that the first contrast obtained by the calculation meets the first preset condition.

Preferably, a method of the arranging a fine-scan position according to a determination result, comprising:

designating the next lens position of the current lens position meeting the first preset condition as the fine-scan position.

Preferably, a method of the controlling the lens to move stepwise along the reverse direction of the preset direction from the fine-scan position with the second step size, and calculating the second contrast of the imaging region corresponding to each lens position, comprising:
dividing the imaging region into a plurality of sub-regions;
controlling the lens to move stepwise along the reverse direction of the preset direction from the fine-scan position with the second step size, and obtaining an imaging contrast of each sub-region corresponding to the current lens position;
calculating the second contrast corresponding to the current lens position according to the imaging contrasts of all the plurality of sub-regions corresponding to the current lens position.

Preferably, a method of the calculating the second contrast corresponding to the current lens position according to the imaging contrast of all the plurality of sub-regions corresponding to the current lens position, comprising:
arranging a weight of contrast for each sub-region, wherein a weight of contrast for a sub-region locating at a center of the imaging region is higher than a weight of contrast for a sub-region locating on a periphery of the imaging region;
performing a weighted calculation on the plurality of imaging contrasts of all the sub-regions corresponding to the current lens position according to the plurality of weights of contrast, so as to obtain the second contrast corresponding to the current lens position.

Preferably, a method of the determining whether each of the second contrasts obtained by the calculation meets the second preset condition, comprising:

if a second preset multiplication of the second contrast corresponding to the current lens position is greater than a second contrast corresponding to the previous lens position and greater than a second contrast corresponding to the next lens position, it is determined that the second contrast having been calculated meets the second preset condition.

Preferably, the automatic focusing method further comprises:

if after a calculation frequency of the second contrast reaches a preset threshold of frequency, none of the second contrasts meets the second preset condition, then calculating the target imaging position by using the current lens position meeting the first preset condition, together with the previous lens position and the next lens position.

Preferably, a method of the calculating the target imaging position by using the current lens position meeting the first preset condition, together with the previous lens position and the next lens position, comprising:
calculating a contrast difference L between the current lens position and the previous lens position, and calculating a contrast difference R between the current lens position and the next lens position;
constructing a find peaks function, wherein the find peaks function is a convex function;
substituting the contrast differences of L and R, the current lens position and the first step size into the find peaks function, to obtain the target imaging position, wherein the target imaging position is expressed as:

$${h}_{peak} = i + \frac{s}{2} \times \frac{L - R}{L + R}$$

wherein i represents the current lens position, s represents the first step size, hₚₑₐₖ represents the target imaging position.

Preferably, the first step size is greater than the second step size.

In order to solve the technical problem stated above, the present application further provides a lens module applied to achieving the automatic focusing method stated above, the lens module comprising:
a lens applied to receiving light to form an optical path;
a photosensitive element comprising an imaging region applied to receiving the light transmitted by the lens, before forming an image;
a motor applied to driving the lens to move, so as to change a distance between the lens and the photosensitive element;
a controller applied to calculating the contrast according to the image formed corresponding to the imaging region before performing a determination, and applied to controlling the motor to drive the lens to move.

In order to solve the technical problem stated above, the present application further provides an imaging device comprising the lens module stated above.

The present application provides the automatic focusing method, the lens module and the imaging device, comprising: controlling the lens to move stepwise along the preset direction from the initial scanning position with the first step size, and calculating the first contrast of the imaging region corresponding to each lens position; determining whether each of the first contrasts obtained by the calculation meets the first preset condition; arranging the fine-scan position according to the determination result; controlling the lens to move stepwise along the reverse direction of the preset direction from the fine-scan position with the second step size, and calculating the second contrast of the imaging region corresponding to each lens position; determining whether each of the second contrasts obtained by calculation meets the second preset condition; if the calculated second contrast meets the second preset condition, designating the lens position corresponding to the second contrast as the target imaging position. By calculating the first contrast and determining whether the first contrast meeting the first preset condition or not, it is possible to determine quickly a range of an imaging focal length, further by calculating the second contrast and determining whether the second contrast meeting the second preset condition or not, it is able to determine the imaging focal length quickly, that is, determining the target imaging position of the lens. Due to a fact that, during a focusing process, not all of the lens positions have to be traversed, and the present application is able to adjust the step size flexibly according to a shooting scene, it is not only possible to reduce a focusing time consumption effectively, but also able to adapt to all kinds of scenes, and a problem of how to achieve high-efficient automatic focusing is solved

### BRIEF DESCRIPTION OF THE DRAWINGS

FIG. 1 illustrates a flow chart on an automatic focusing method according to an embodiment of the present application;

FIG. 2 illustrates a schematic diagram on arranging a weight of contrast according to an embodiment of the present application;

FIG. 3 illustrates a schematic diagram on a curve of a find_peaks function according to an embodiment of the present application;

FIG. 4 illustrates a schematic structural diagram on a lens module according to an embodiment of the present application;

Wherein: 101—lens; 102—photosensitive element; 103—motor; 104—controller.

### DESCRIPTION OF THE EMBODIMENTS

The following provides a further detailed explanation on a transcendental function calculation system and method based on interpolation approximation, a chip and a terminal device proposed by the present application, in conjunction with the accompanying drawings and specific embodiments. It should be noted that the accompanying drawings are all in a very simplified form and using imprecise proportions, only for the convenience and clarity of assisting in explaining the purpose of the embodiments of the present application. In addition, the structure shown in the accompanying drawings is often a part of the actual structure. Specifically, the emphasis shown in each of the accompanying drawings is different, and sometimes different proportions may be adopted.

It is noted that the terms “first”, “second”, and more, used in the specification, claims, and accompanying drawings of the present application are intended to distinguish similar objects, in order to describe the embodiments of the present application, instead of describing a specific order or sequence. It should be understood that the structures used in this way may be interchangeable in appropriate circumstances. In addition, the terms ‘including’ and ‘having’, as well as any variations thereof, are intended to cover non-exclusive inclusions, such as processes, methods, systems, products, or devices that contain a series of steps or units, that are not necessarily limited to those having been clearly listed, but may also include other steps or units that are not clearly listed or inherent to these processes, methods, products, or devices.

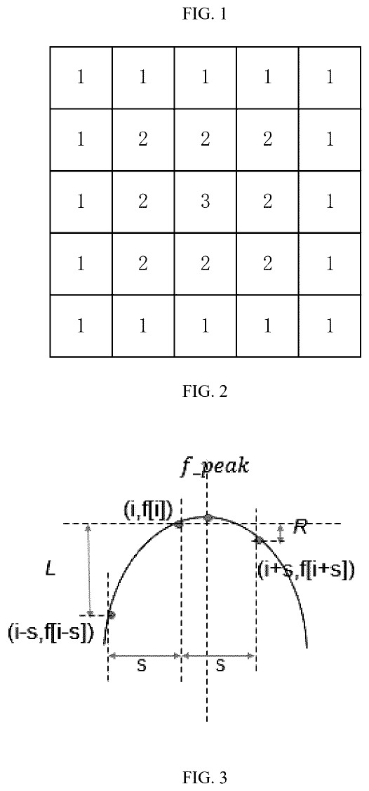

An automatic focusing method is provided in an embodiment of the present application, shown as FIG. 1, comprises:
S1, controlling a lens to move stepwise along a preset direction from an initial scanning position with a first step size, and calculating a first contrast of an imaging region corresponding to each lens position;
S2, determining whether each of the first contrasts obtained by the calculation meets a first preset condition;
S3, arranging a fine-scan position according to a determination result;
S4, controlling the lens to move stepwise along a reverse direction of the preset direction from the fine-scan position with a second step size, and calculating a second contrast of the imaging region corresponding to each lens position;
S5, determining whether each of the second contrasts obtained by calculation meets a second preset condition;
S6, if a calculated second contrast meets the second preset condition, designating a lens position corresponding to the second contrast as a target imaging position.

The automatic focusing method provided in an embodiment of the present application, by calculating the first contrast and determining whether the first contrast meeting the first preset condition or not, is possible to determine quickly a range of an imaging focal length, further by calculating the second contrast and determining whether the second contrast meeting the second preset condition or not, it is able to determine the imaging focal length quickly, that is, determining the target imaging position of the lens. Due to a fact that, during a focusing process, not all of the lens positions have to be traversed, and the present application is able to adjust the step size flexibly according to a shooting scene, it is not only possible to reduce a focusing time consumption effectively, but also able to adapt to all kinds of scenes, and a problem of how to achieve high-efficient automatic focusing is solved

Specifically, in the present embodiment, a method of the step S1, controlling a lens to move stepwise along a preset direction from an initial scanning position with a first step size, and calculating a first contrast of an imaging region corresponding to each lens position, comprises:
S11, arranging the initial scanning position.

Considering that in an actual imaging operation, the lens is inherently spaced apart from a photosensitive element by a preset distance, and that the lens is initially positioned at its infinity focus location (calibrated for parallel light incidence) to enable rapid focusing. Therefore, it is possible to arrange an initial scanning position, so that the automatic focusing process is directly carried out from the initial scanning position, instead of being carried out from an extreme proximal or distal position relative to the photosensitive element, so as to reduce the focusing time.

In an actual implementation, the initial scanning position needs to be comprehensively determined according to a movement direction and a focus position during a lens focusing. In an embodiment, if the lens starts to move in a direction away from the photosensitive element, it is possible to arrange the initial scanning position on a side of the focus close to the photosensitive element, so that at a same time of saving the focusing time, it is able to scan the focus position, to ensure finding the target imaging position of the lens in the automatic focusing process.
S12, dividing the imaging region into a plurality of sub-regions.

Considering that in an actual imaging operation, it is usually focusing and shooting on a certain area position in the imaging region of the photosensitive element, so that an area where a key shooting element is located can be photographed clearly. Therefore, it is possible to divide the imaging region of the photosensitive element into a plurality of sub-regions, so that during a subsequent calculation for the contrast, it is possible to adjust the target imaging position of the lens according to a shooting requirement, so as to grantee that the key shooting element in a final image is clear.

In an actual implementation, it is possible to determine the division of the sub-regions comprehensively according to a plurality of factors of the image having been photographed including a size, a range being able to image clearly, and more, and including a size, a position and more of each of the sub-regions. Obviously, in order to facilitate a subsequent calculation, the sizes of the sub-regions may be arranged as a uniform size, and different sub-regions are adjacent to each other.
S13, controlling the lens to move stepwise along the preset direction from the initial scanning position with the first step size, and obtaining an imaging contrast of each sub-region corresponding to a current lens position.

A calculation method of the imaging contrast of each sub-region is well known to a person skilled in the art, thus no more details are described herein again. In the present application, it is possible to select a method of calculating the contrast from an existing CDAF method.
S14, calculating the first contrast corresponding to the current lens position according to the plurality of imaging contrasts of all the sub-regions corresponding to the current lens position.

In the present embodiment, first, arranging a weight of contrast for each sub-region, wherein a weight of contrast for a sub-region locating at a center of the imaging region is higher than a weight of contrast for a sub-region locating on a periphery of the imaging region.

In an embodiment, the imaging region is divided into 5×5 sub-regions, shown as FIG. 2, when taken the center of the imaging region as a focusing region, a weight of contrast of a sub-region located at the center can be set to be 3 (a highest), a weight of contrast of eight sub-regions adjacent to the sub-region at the center is set to be 2, and a weight of contrast of 16 sub-regions at an outermost periphery is set to 1 (a lowest), thereby ensuring that more consideration is applied to a central region when calculating the target imaging position of the lens, so that the central region in a final imaging has a higher definition.

Obviously, in a plurality of other embodiments, it is possible to assign different weights of contrast to different sub-regions at different positions according to different focusing regions. And it is possible to assign a weight of contrast for each focusing region flexibly.

And performing a weighted calculation on the plurality of imaging contrasts of all the sub-regions corresponding to the current lens position according to the plurality of weights of contrast, so as to obtain the first contrast corresponding to the current lens position.

It is noted that during a same focusing process, when calculating the first contrast for each lens position, a value of the weight of contrast for each sub-region should be consistent, so as to ensure a consistency of a calculation result of the first contrast.

Further, in the present embodiment, a method of the step of S2, determining whether each of the first contrasts obtained by the calculation meets the first preset condition, comprises:

if a first preset multiplication of the first contrast corresponding to the current lens position is greater than a first contrast corresponding to a previous lens position and greater than a first contrast corresponding to a next lens position, it is determined that the first contrast having been calculated meets the first preset condition. Wherein a value of the first preset multiplication is greater than 0, but less than 1.

In a specific embodiment, assuming that the current lens position is i, the first step size is 1, the first preset multiplication is 0.75, the first contrast of the current lens position is recorded as d1(i), the first contrast of the previous lens position is denoted as d1(i−1), and the first contrast of the next lens position is denoted as d1(i+1), then if 0.75 d1(i)>d1(i−1) and 0.75 d1(i)>d1(i+1), it is determined that d1(i) meets the first preset condition.

Obviously, in a plurality of other embodiments, a value of the first preset multiplication and a value of the first step size can be determined comprehensively according to a requirement of both focusing range and imaging definition of the lens, which is not limited in the present application.

Now it is determined that the target imaging position of the lens is between i−1 and i+1. So far, a coarse adjustment process of focusing is completed.

Further, in the present embodiment, the step S3, arranging a fine-scan position according to a determination result.

Specifically, since when the lens is roughly adjusted in the preset direction, it has determined that the target imaging position of the lens is between i−1 and i+1. Thus, in order to reduce a calculation amount as much as possible, but increase a focusing speed, in the present embodiment, designating the next lens position of the current lens position meeting the first preset condition as the fine-scan position, that is, assigning the position of i+1 as the fine-scan position.

Further, in the present embodiment, the step of S4, controlling the lens to move stepwise along the reverse direction of the preset direction from the fine-scan position with the second step size, and calculating the second contrast of the imaging region corresponding 100003 L to each lens position.

Similar to the step of S1, the step of S4 comprises specifically:
S41, dividing the imaging region into a plurality of sub-regions.

In an actual implementation, in order to simplify a calculation process and ensure a consistency of calculation, it is possible to still adopt a division mode for sub-regions as disclosed in the step S12, that is, the sub-regions formed by segmentation according to the step S12 is still adopted for a subsequent calculation.
S42, controlling the lens to move stepwise along the reverse direction of the preset direction from the fine-scan position with the second step size, and obtaining an imaging contrast of each sub-region corresponding to the current lens position.

In the present step, since it requires a fine confirmation to the target imaging position of the lens, thus the second step size should be less than the first step size. And a calculation method of the imaging contrast adopted in the present step can be consistent with the calculation method of the imaging contrast adopted in the step S13, thus it is able to reduce a hardware resource consumed by a storage algorithm effectively.

In a specific embodiment, when the first step size is arranged as 1, the second step size may be arranged as 0.25.
S43, calculating the second contrast corresponding to the current lens position according to the imaging contrasts of all the plurality of sub-regions corresponding to the current lens position.

In the present embodiment, first, arranging a weight of contrast for each sub-region, wherein a weight of contrast for a sub-region locating at a center of the imaging region is higher than a weight of contrast for a sub-region locating on a periphery of the imaging region. In a real implementation, the weight of contrast arranged in the present step can be same as the weight of contrast arranged in the step S14, so as to ensure a consistency of two contrast calculation results.

Then, performing a weighted calculation on the plurality of imaging contrasts of all the sub-regions corresponding to the current lens position according to the plurality of weights of contrast, so as to obtain the second contrast corresponding to the current lens position.

Further, in the present embodiment, a method of the step S5, determining whether each of the second contrasts obtained by calculation meets the second preset condition, comprises:

if a second preset multiplication of the second contrast corresponding to the current lens position is greater than a second contrast corresponding to the previous lens position and greater than a second contrast corresponding to the next lens position, it is determined that the second contrast having been calculated meets the second preset condition. Wherein a value of the second preset multiplication is greater than 0, but less than 1.

In a specific embodiment, assuming that the current lens position is i, the second step size is 0.25, the second preset multiplication is 0.75, the second contrast of the current lens position is recorded as d2(i), the second contrast of the previous lens position is denoted as d2(i+0.25), and the second contrast of the next lens position is denoted as d2(i−0.25), then if 0.75 d2(i)>d2(i−0.25) and 0.75 d2(i)>d2(i+0.25), it is determined that d2(i) meets the second preset condition. Wherein it is noted that, when calculating the second contrast, the lens starts from the fine-scan position in the direction opposite to the preset direction, thus the previous lens position of the current lens position is i+0.25, and the next lens position is i−0.25.

Obviously, in a plurality of other embodiments, a value of the second preset multiplication and a value of the second step size can be determined comprehensively according to the requirement of both the focusing range and the imaging definition of the lens, which is not limited in the present application.

Now it is determined that the target imaging position of the lens is between i−0.25 and i+0.25. Due to the fact that the second step size is smaller, generally the imaging definition of the current lens position having been determined can meet the requirement. Thus a fine adjustment process of focusing is completed.

S6, if a calculated second contrast meets the second preset condition, designating a lens position corresponding to the second contrast as the target imaging position.

Since a calculated contrast is positively correlated with the imaging definition, that is, when the imaging definition is the best, the contrast is the highest, and at this time, a corresponding lens position is an imaging focal position. Therefore, through the plurality of steps stated above, it is possible to obtain the lens position (the imaging focal position) when the contrast is a maximum (the definition is a best), and by assigning the lens position as the target imaging position, it is able to obtain a shooting effect with the best definition.

Now a whole automatic focusing process is completed. By means of a coarse adjustment followed by a fine adjustment, it is possible to find the lens position corresponding to the point generating a clearest image in a hill climbing mode Different from an existing CDAF mode, in the present embodiment, a coarse adjustment process does not have to traverse all the positions of the lens, thus saving a large amount of time, and improving a focusing efficiency. Further, in the present embodiment, when comparing the contrast, it adopts the first preset multiplication and the second preset multiplication to scale the current lens position, thus it is not only able to determine a range of the target imaging position of the lens more quickly, but also able to reduce a size of a determined range as much as possible, which improves focusing accuracy while improving the focusing efficiency.

In addition, in order to further improve the focusing efficiency, in the present embodiment, the automatic focusing method further comprises:

S7, if after a calculation frequency of the second contrast reaches a preset threshold of frequency, none of the second contrasts meets the second preset condition, then calculating the target imaging position by using the current lens position meeting the first preset condition, together with the previous lens position and the next lens position.

In an embodiment, when the calculation frequency of the second contrast reaches 5 times (the position of the lens in a fine adjustment process has been gradually changed for 5 times), it still has not found the point with the maximum contrast, then in order to save the focusing time, a step-by-step contrast comparison is no more carried out, instead, adopting the current lens position meeting the first preset condition, together with the previous lens position and the next lens position, to calculate the target imaging position.

Specifically, considering that both the lens position and the imaging definition (the contrast) conform to a feature of a convex function (a quadratic function), thus in the present embodiment, it is possible to fit a convex function by using the current lens position meeting the first preset condition, together with the previous lens position and the next lens position, followed by using the convex function to obtain a maximum value, and obtain the target imaging position.

In a real implementation, shown as FIG. 3, suppose a quadratic function ƒ(x)=a(x−h)²+k is a find peaks function, wherein (h,k) represents a maximum value of the quadratic function, h represents the target imaging position of the lens, and k represents a maximum value of the first contrast.

During a coarse adjustment process, it is obtained that a current lens position satisfying the first preset condition is i, and a first contrast thereof is ƒ(i); a previous position of the current lens position is i−s, and a first contrast thereof is ƒ(i−s); a next position to the current lens position is i+s, and a first contrast thereof is ƒ(i+s); wherein s is the first step size.

Since three points of (i−s,ƒ(i−s)), (i,ƒ(i)) and (i+s,ƒ(i+s)) are all satisfying the find peaks function of ƒ(x)=a(x−h)²+k, thus, by taking the three points into the find peaks function, a value of h will be obtained.

In addition, since three abscissas of the three points of (i−s,ƒ(i−s)), (i,ƒ(i)) and (i+s,ƒ(i+s)) are equidistant, thus it is possible to calculate a contrast difference value L between the current lens position and the previous lens position, and a contrast difference R between the current lens position and the next lens position, that is, L=ƒ(i)−ƒ(i−s), and R=ƒ(i)−ƒ(i+s). By an equation transformation, ƒ(i−s)=ƒ(i)−L, ƒ(i+s)=ƒ(i)−R, that is, three coordinates of the three points become (i−s,ƒ(i)−L), (i, ƒ(i)) and (i+s,ƒ(i)−R).

Now, the coordinates of the three points after transformation are substituted into the find peaks function, to obtain the target imaging position, wherein the target imaging position is expressed as:

$${h}_{peak} = i + \frac{s}{2} \times \frac{L - R}{L + R}$$

wherein, i represents the current lens position, s represents the step size, hₚₑₐₖ represents the target imaging position.

In such a way, by using the three points for a function fitting, it is able to obtain the target imaging position quickly, improving the focusing efficiency.

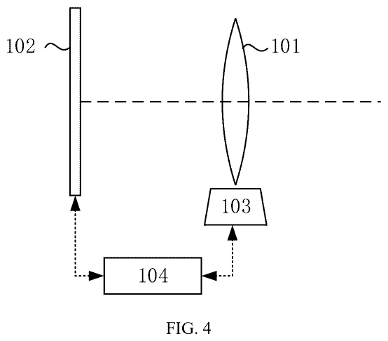

The present embodiment further provides a lens module, applied to achieving the automatic focusing method described above, shown as FIG. 4, the lens module comprises:
a lens 101 applied to receiving light to form an optical path;
a photosensitive element 102 comprising an imaging region applied to receiving the light transmitted by the lens 101, before forming an image;
a motor 103 applied to driving the lens 101 to move, so as to change a distance between the lens 101 and the photosensitive element 102;
a controller 104 applied to calculating the contrast according to the image formed corresponding to the imaging region before judging and controlling the motor 103 to drive the lens 101 to move.

According to the lens module provided in the present embodiment, since a focusing process does not need to traverse all of the lens positions, and the step size can be flexibly adjusted according to a shooting scene, not only a focusing time consumption can be effectively reduced, but also the lens module is suitable for a plurality of kinds of scenes, thus it has solved the problem of how to achieve efficient automatic focusing.

In a practical application, the lens 101 may be a lens group formed by combining a plurality of lenses; the photosensitive element 102 may be an image sensor; while a positional relationship and a connection relationship between the lens 101, the photosensitive element 102, the motor 103, and the controller 104, as long as a mechanical structure and a circuit design are well known to a person skilled in the art, thus no more details are repeated herein.

Further, the present embodiment provides an imaging device comprising the lens module described above.

In a practical implementation, the imaging device comprises, but is not limited to, a camera, a camcorder, a monitor, and more.

It should be noted that the embodiments in the present specification are described in a progressive manner, each embodiment focuses on differences from other embodiments, and the same or similar parts between the embodiments can be referred to each other; in addition, different parts between the embodiments can also be used in combination, which is not limited in the present disclosure.

The present embodiment provides the automatic focusing method, the lens module and the imaging device, comprising: controlling the lens to move stepwise along the preset direction from the initial scanning position with the first step size, and calculating the first contrast of the imaging region corresponding to each lens position; determining whether each of the first contrasts obtained by the calculation meets the first preset condition; arranging the fine-scan position according to the determination result; controlling the lens to move stepwise along the reverse direction of the preset direction from the fine-scan position with the second step size, and calculating the second contrast of the imaging region corresponding to each lens position; determining whether each of the second contrasts obtained by calculation meets the second preset condition; if the calculated second contrast meets the second preset condition, designating the lens position corresponding to the second contrast as the target imaging position. By calculating the first contrast and determining whether the first contrast meeting the first preset condition or not, it is possible to determine quickly a range of an imaging focal length, further by calculating the second contrast and determining whether the second contrast meeting the second preset condition or not, it is able to determine the imaging focal length quickly, that is, determining the target imaging position of the lens. Due to a fact that, during a focusing process, not all of the lens positions have to be traversed, and the present application is able to adjust the step size flexibly according to a shooting scene, it is not only possible to reduce a focusing time consumption effectively, but also able to adapt to all kinds of scenes, and a problem of how to achieve high-efficient automatic focusing is solved

While the embodiments of the present application have been described in detail, it will be apparent to those skilled in the art that various modifications and changes can be made to the embodiments. However, it is to be understood that such modifications and variations are within the scope and spirit of the present invention as described in the appended claims. Furthermore, the present invention described herein is susceptible to other embodiments and may be embodied or carried out in various ways.

What is claimed is:

1. An automatic focusing method, wherein comprising:
controlling a lens to move stepwise along a preset direction from an initial scanning position with a first step size, and calculating a first contrast of an imaging region corresponding to each lens position;
determining whether each of the first contrasts obtained by the calculation meets a first preset condition;
arranging a fine-scan position according to a determination result;
controlling the lens to move stepwise along a reverse direction of the preset direction from the fine-scan position with a second step size, and calculating a second contrast of the imaging region corresponding to each lens position;
determining whether each of the second contrasts obtained by calculation meets a second preset condition;
if a second contrast obtained by calculation meets the second preset condition, designating a lens position corresponding to the second contrast as a target imaging position.

2. The automatic focusing method according to claim 1, wherein the method of the controlling a lens to move stepwise along a preset direction from an initial scanning position with a first step size, and calculating a first contrast of an imaging region corresponding to each lens position, comprising:
arranging the initial scanning position;
dividing the imaging region into a plurality of sub-regions;
controlling the lens to move stepwise along the preset direction from the initial scanning position with the first step size, and obtaining an imaging contrast of each sub-region corresponding to a current lens position;
calculating the first contrast corresponding to the current lens position according to the plurality of imaging contrasts of all the sub-regions corresponding to the current lens position.

3. The automatic focusing method according to claim 2, wherein the method of calculating the first contrast corresponding to the current lens position according to the plurality of imaging contrasts of all the sub-regions corresponding to the current lens position, comprising:
arranging a weight of contrast for each sub-region, wherein a weight of contrast for a sub-region locating at a center of the imaging region is higher than a weight of contrast for a sub-region locating on a periphery of the imaging region;
performing a weighted calculation on the plurality of imaging contrasts of all the sub-regions corresponding to the current lens position according to the plurality of weights of contrast, so as to obtain the first contrast corresponding to the current lens position.

4. The automatic focusing method according to claim 1, wherein the step of determining whether each of the first contrasts obtained by the calculation meets the first preset condition, comprising:
if a first preset multiplication of the first contrast corresponding to the current lens position is greater than a first contrast corresponding to a previous lens position and greater than a first contrast corresponding to a next lens position, it is determined that the first contrast obtained by the calculation meets the first preset condition.

5. The automatic focusing method according to claim 4, wherein the step of arranging a fine-scan position according to a determination result, comprising:
designating the next lens position of the current lens position meeting the first preset condition as the fine-scan position.

6. The automatic focusing method according to claim 1, wherein a method of the controlling the lens to move stepwise along the reverse direction of the preset direction from the fine-scan position with the second step size, and calculating the second contrast of the imaging region corresponding to each lens position, comprising:
dividing the imaging region into a plurality of sub-regions;
controlling the lens to move stepwise along the reverse direction of the preset direction from the fine-scan position with the second step size, and obtaining an imaging contrast of each sub-region corresponding to the current lens position;
calculating the second contrast corresponding to the current lens position according to the imaging contrasts of all the plurality of sub-regions corresponding to the current lens position.

7. The automatic focusing method according to claim 6, wherein a method of the calculating the second contrast corresponding to the current lens position according to the imaging contrast of all the plurality of sub-regions corresponding to the current lens position, comprising:
arranging a weight of contrast for each sub-region, wherein a weight of contrast for a sub-region locating at a center of the imaging region is higher than a weight of contrast for a sub-region locating on a periphery of the imaging region;
performing a weighted calculation on the plurality of imaging contrasts of all the sub-regions corresponding to the current lens position according to the plurality of weights of contrast, so as to obtain the second contrast corresponding to the current lens position.

8. The automatic focusing method according to claim 1, wherein a method of the determining whether each of the second contrasts obtained by the calculation meets the second preset condition, comprising:
if a second preset multiplication of the second contrast corresponding to the current lens position is greater than a second contrast corresponding to the previous lens position and greater than a second contrast corresponding to the next lens position, it is determined that the second contrast having been calculated meets the second preset condition.

9. The automatic focusing method according to claim 4, further comprising:
if after a calculation frequency of the second contrast reaches a preset threshold of frequency, none of the second contrasts meets the second preset condition, then calculating the target imaging position by using the current lens position meeting the first preset condition, together with the previous lens position and the next lens position.

10. The automatic focusing method according to claim 9, wherein a method of the calculating the target imaging position by using the current lens position meeting the first preset condition, together with the previous lens position and the next lens position, comprising:
calculating a contrast difference L between the current lens position and the previous lens position, and calculating a contrast difference R between the current lens position and the next lens position;
constructing a find peaks function, wherein the find peaks function is a convex function;
substituting the contrast differences of L and R, the current lens position and the first step size into the find peaks function, to obtain the target imaging position, wherein the target imaging position is expressed as:
$${h}_{peak} = i + \frac{s}{2} \times \frac{L - R}{L + R}$$
wherein i represents the current lens position, s represents the first step size, hₚₑₐₖ represents the target imaging position.

11. The automatic focusing method according to claim 1, wherein the first step size is greater than the second step size.

12. A lens module applied to achieving the automatic focusing method according to claim 1, comprising:
a lens applied to receiving light to form an optical path;
a photosensitive element comprising an imaging region applied to receiving the light transmitted by the lens, before forming an image;
a motor applied to driving the lens to move, so as to change a distance between the lens and the photosensitive element;
a controller applied to calculating the contrast according to the image formed corresponding to the imaging region before performing a determination, and applied to controlling the motor to drive the lens to move.

13. An imaging device comprising the lens module according to claim 12.
